(19) United States
(12) Patent Application Publication
(10) Pub. No.: US 2006/0015872 A1
(43) Pub. Date: Jan. 19, 2006

(54) Process management

(76) Inventors: William N. Pohl, Morgan Hill, CA (US); Eric W. Hamilton, Mountain View, CA (US); Harshadrai G. Parekh, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/074,983

(22) Filed: Mar. 8, 2005

Related U.S. Application Data
(60) Provisional application No. 60/587,445, filed on Jul. 13, 2004.

(51) Int. Cl. G06F 9/46

(52) U.S. Cl. 718/100

(57) ABSTRACT

Systems, methods, and device are provided for process management. One method embodiment includes, in a system process, starting an orphan collector thread (OCT) which is dedicated to cleaning up orphaned children processes adopted by the system process. The orphaned children processes are flagged when adopted by the system process. The OCT will execute a function call to clean up only processes which are flagged as having been adopted by the system process and which have terminated.

### CROSS-REFERENCE TO RELATED APPLICATIONS

This application claims the benefit of U.S. Provisional Application No. 60/587,445, filed Jul. 13, 2004, the entire content of which is incorporated herein by reference.

### BACKGROUND

A computing device, such as a server, router, desktop computer, laptop, etc., and other devices having processor logic and memory, includes an operating system layer and an application layer to enable the device to perform various functions or roles. The operating system layer includes a master control program that runs the computing device. The master control program provides task management, device management, and data management, among others. The operating system layer contains an operating system that sets the standards for application programs that run on the computing device. Before a computing device may accomplish a desired task, it must receive an appropriate set of instructions. Executed by a device's processor(s), these instructions direct the operation of the device. These instructions can be stored in a memory of the computer. Instructions can invoke other instructions. Application layers are considered to be logic layers which are located above the operating system layer. As used herein, “user” space, or “user-mode” implies a layer of code which is more easily accessible, e.g., includes open-source code, than the layer of code which is in the operating system layer or “kernel” space.

In an operating system, a process refers to a running program with input, output, and a state. Each process has one or more threads. A thread is an executable set of instructions being executed by a single processor. A thread is sometimes referred to as a lightweight process. For example, a process contains attributes shared by all executing threads in the in the process, such as an address space, file descriptors, and variables of an executing instance of a program. Processes and threads are well known in the art and are described, for example, in Modern Operating Systems, Andrew S. Tannenbaum, (1992).

A process may start one or many other processes. A process which starts another is referred to as a parent process and the process which was started thereby is referred to as the child process. In operating system semantics parent processes are responsible for “waiting on” (e.g., cleaning up) their child(ren) process(es) when the child(ren) process(es) are completed. When a parent process exits or ends before the child(ren) process(es), the responsibility for the child(ren) process(es) (e.g., orphaned processes) are turned over to (e.g., adopted by) a system process. This is just one of example of how processes are “orphaned” to the system. The system process has restrictions placed on its scheduling priorities. That is, the system process has its own set of responsibilities including starting and restarting other processes. Additionally, the system process may be single threaded. These factors can thus create a scaling bottle neck on systems with a high rate of processes being given to, or adopted by, the system process. The existence of uncollected, “orphaned” processes can consume system resources, including memory, result in enlarging data structures (process entries, thread table entries, etc.), and so forth, which can diminish a system's performance.

### BRIEF DESCRIPTION OF THE DRAWINGS

FIG. 1A is an illustration of the process/thread relationship in the computing arts.

FIG. 1B is a block diagram illustration of a computing system suitable for implementing process management embodiments of the present invention.

FIG. 2A is a block diagram illustration of an embodiment for a parent process to child process relationship.

FIG. 2B is another block diagram illustration of an embodiment for parent and child process relationship including a system process representation.

FIG. 2C illustrates another detail level for a system process representation according to an embodiment of the present invention.

FIG. 3A illustrates an embodiment for thresholding orphan collector threads (OCTs).

FIG. 3B serves to illustrate considerations which exemplify the benefits of thresholding OCTs according to various embodiments of the present invention.

FIGS. 4-5 illustrate various method embodiments for process management.

### DETAILED DESCRIPTION

A process has responsibilities such as starting (e.g., “spawning”) a new process and restarting (e.g., “respawning”) processes that have ended or improperly gone away. As mentioned above, a process will have one or more threads, e.g., sets of instructions being executed by a single physical processor. A system process, such as the “init” process in Unix semantics, is responsible for initializing a system, but additionally has its own set of responsibilities, like any other process, for starting new processes and restarting processes that have ended or improperly gone away. For example, a system process may have the responsibility for starting a web server, among other things, and restarting the web server when it has improperly ended or exited.

A process is not responsible for restarting another process which it did not create. Thus, if as describe above, a parent process goes away or end before its child process, the child process will not be restarted by another process. A process, however, can clean up or remove a process which it did not create. A system process is usually responsible for cleaning up (e.g. adopting) these “orphaned” processes. The system process knows when an orphaned process has been turned over to it for cleaning up. That is, the orphaned process is marked or flagged as having been handed over to the system process. As one of ordinary skill in the art will appreciate upon reading this disclosure, this can occur in a code path of the “kernel” operating system. This is true whether the operating system is a Unix, Linux, AIX, or Mac based operating system, etc.

When a system process begins it will have one or more threads of execution for a single physical processor. According to embodiments of the present invention, when the system process begins it additionally starts at least one thread of execution which can run on another physical processor separate from its other responsibilities, e.g., threads of execution. This at least one additional thread is responsible for cleaning up the orphaned processes that have been turned over to the system process. When a child process is orphaned to the system process, its structure is marked with a flag as having been “adopted” by the system process at the time the parent process is changed. This new flag will only be used by the system process. When the flag is used, the system process will only reap adopted children processes that have terminated. The additional thread responsible for cleaning up this the orphaned processes that have been turned over to the system process will have no other purpose than cleaning up these adopted children processes that have terminated. The at least one additional thread will be referred to herein as a “orphan collector thread” (OCT). When the OCT wants to clean up orphaned processes it makes a call to the system to “wait on” the orphaned processes. According to the various embodiments, the OCT is only responsible for collecting orphaned processes. As such, the OCT can be contained in a very tight segment of code on the order of tens of lines of codes versus thousands and be run in more approximately real time than threads with which possess multiple responsibilities. A threshold can be established, and selectably varied by user input, such that the OCT will “wait on” orphaned processes only after a requisite number of orphaned processes have been turned over to the system process. Further, more than one OCT can be started by the system process based on another threshold, also selectably variable by user input, such that the number of OCT's in existence is responsive to various volumes of orphaned processes.

In the following description, for purposes of explanation, numerous details are set forth in order to provide a thorough understanding of the present invention. However, it will be apparent to one skilled in the art that these specific details are not required in order to practice the present invention. In other instances, well known electrical structures and circuits are shown in block diagram form in order not to obscure the present invention.

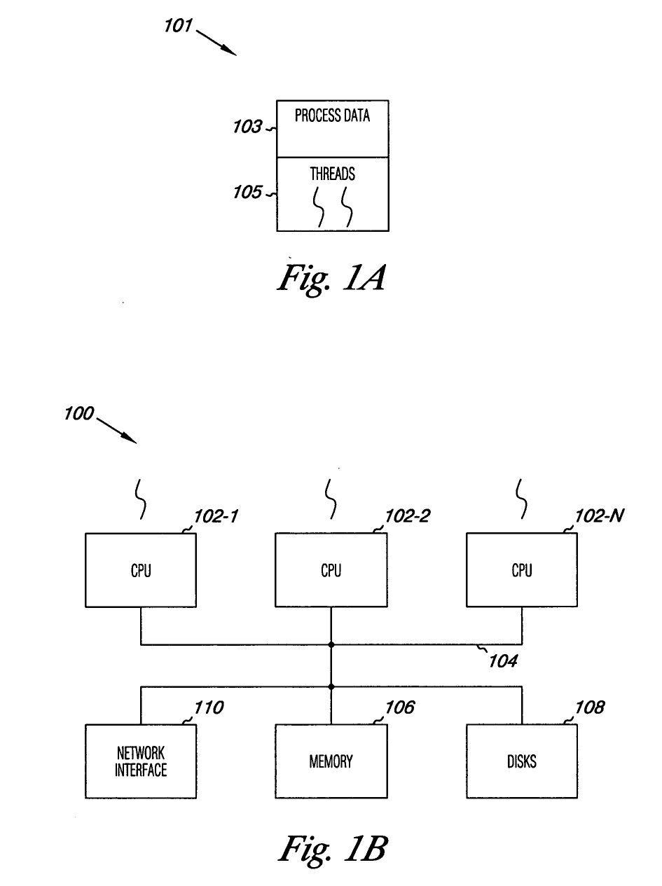

FIG. 1A is an illustration of the process/thread relationship 101 in the computing arts. As one of ordinary skill in the art will appreciate, a “thread is a set of executable instructions that can be executed, e.g., “run”, on a processor. A thread, shown at 105, contains the executable instructions used to execute a task. For example, a thread can represent a client connection in a client/server system as the same will be appreciated by one of ordinary skill in the art upon reading this disclosure. A process, illustrated at 103, is a collection of data that is accessible by a thread and may be shared by a group of threads. A process may contain a single thread or may contain multiple threads. By way of example, and not by way of limitation, FIG. 1A illustrates two threads, 111-1 and 111-2.

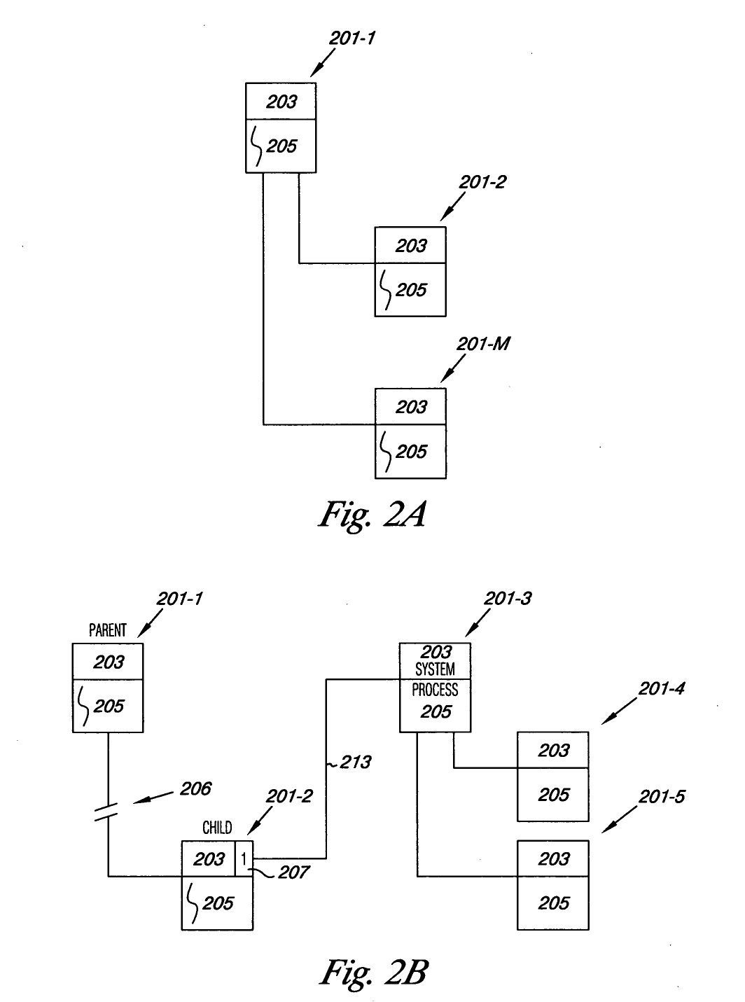

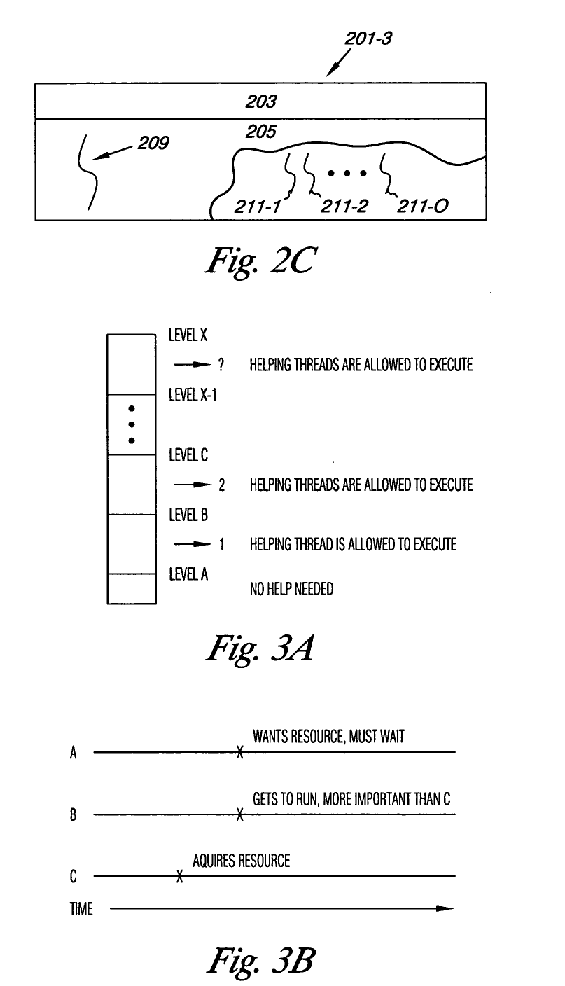

As noted above and discussed more in connection with FIGS. 2A and 2B, a process may start (e.g., “spawn”) other processes. The “parent” process is responsible and oversees, e.g., controls, the “child” process. A parent may control several concurrently operating child processes. Additionally, each child process may have several threads of various types that can be in one of several states.

FIG. 1B is a block diagram illustration of a computing system 100 suitable for implementing process management embodiments of the present invention. The embodiment of FIG. 1B illustrates a multi-threaded system. FIG. 1B also illustrates a multi-processor system in which a number of processors 102-1, 102-2, . . . , 102-N are shown. One of ordinary skill in the art will appreciate upon reading this disclosure the various types of processors which can be implemented as suited to carrying out the various embodiments of the present invention. Embodiments, however, are not limited to this example or to the number and type of processors. As shown in FIG. 1B, the number of processors 102-1, 102-2, . . . , 102-N have connections to one another and other system components via connections 104. For example, FIG. 1B illustrates that the number of processors 102-1, 102-2, . . . , 102-N are coupled to memory 106. Memory 106 includes system memory in the form of random access memory (RAM) and read only memory (ROM), cache memory, etc. The number of processors 102-1, 102-2, . . . , 102-N can be connected to memory 106 via a host or memory bus as the same will be appreciated by one of ordinary skill in the art. Memory 106 can be used as a general storage area and as scratch pad memory. Memory 106 can store programming instructions and data associated with the operating system and can include shared allocated memory for multiple threads in multiple processes. Memory 106 likewise can store basic operating instructions, program code, data and objects used, e.g., executed, by the number of processors to perform functions on the system 100.

FIG. 1B additionally illustrates connections 104, e.g., via a peripheral bus, to other subsystems and devices. These other subsystems and devices can include removable and fixed mass storage disks 108, network interfaces 110, auxiliary input/output (I/O) devices (not shown) such as microphones, speakers, touch sensitive displays, voice or handwriting recognizers, biometric readers, cameras, etc., among others.

Fixed mass storage can include hard disk drives and removable mass storage can include non-volatile and volatile memory such as Flash memory, compact disks (CDs), floppy disks, portable memory keys, and other magnetic and/or optical memory mediums, etc. Embodiments are not limited to these examples.

Network interfaces 110 can include internet connections as well as intranets, local area networks (LANs), enterprise networks, wide area networks (WANs), etc., whether wirelessly accessed or otherwise. Network interfaces 110 allow the number of processors 102-1, 102-2, . . . , 102-N to be connected to other computers, e.g., laptops, workstations, desktops, servers, etc., and computer networks, or telecommunications network using various network connection types and associated protocols as one of ordinary skill in the art will appreciate upon reading this disclosure.

The number of processors 102-1, 102-2, . . . , 102-N can receive information, e.g., data objects or program instructions, from another network and can output information to other network in connection with performing embodiments discussed herein. One of ordinary skill in the art will further appreciate that information in the form of computer executable instructions may be embodied in a carrier wave.

FIG. 2A is a block diagram illustration of an embodiment for a parent process to child process relationship. The embodiment of FIG. 2A illustrates a number of processes, shown as 201-1, 201-2, . . . , 201-M, which can run on a system 100 such as illustrated in FIG. 1B. A process, e.g., 201-1, on the system that starts another process, e.g., 201-2 and 201-M, is referred to as the “parent” process. The processes, e.g., 201-2 and 201-M, that the “parent” started are referred to as the “child(ren)” process(es). One of ordinary skill in the art will appreciate that the parent process is expected to “clean up”, or wrap up the execution of, its children processes upon the completion of their execution, e.g., when they finish their tasks. The parent process additionally has the responsibility for restarting its children processes if they have inappropriately or prematurely ended or terminated. The parent process performs these responsibilities by executing function calls, as the same will the same are understood by one of ordinary skill in the art. For example, when a child process ends the parent process will invoke a “wait on” function call to link to and use, e.g., execute, a subroutine to release the resources, e.g., memory, data structures, process entries, thread table data entries, etc., occupied by the child process to aid the system in running at optimal performance.

When a parent goes away, e.g., terminates, and it still has children in existence, the children processes are “adopted” by a system process. Similarly, “orphaned” children processes are adopted by the system process if a parent process indicates that it will not “clean up” its children. In other words, a system process is assigned the responsibility of cleaning up orphaned children processes which it did not start. The system process does not attempt to restart processes which it did not create.

FIG. 2B is another block diagram illustration of an embodiment for parent and child process relationship including a system process representation 201-3. That is, the embodiment of FIG. 2B illustrates a parent process 201-1, with its respective process data 203 and one or more threads 205, which has spawned a child process 201-2, also having process data 203 and one or more threads 205. As illustrated in the embodiment of FIG. 2B, a connection between the parent process 201-1 and the child process 201-2 has terminated 206 before the child process 201-2 has completed such that the child process 201-2 has been orphaned with resources on the system still occupied. When this occurs the child process 201-2 is given over to the system process 201-3. That is, a new bond or connection 213 is made between the orphaned child process 201-2 and the system process 201-3. The system process 201-3 knows when processes have been given to it via a code path in the kernel operating system. For example, when a child process is given to the system process a flag 207 in the child process 201-2 is marked as being handed over to the system process 201-3. This “flag” indicates that the child process 201-2 has been adopted by the system process 201-3. One of ordinary skill in the art will appreciate upon reading this disclosure the manner in which a flag can be marked in a process which has been adopted by the system process.

FIG. 2B further illustrates that the system process has additional responsibility beyond cleaning up orphaned processes. For example, the embodiment of FIG. 2B illustrates a number of children processes 201-4 and 201-5, each having their respective process data 203 and threads 205, which were started by the system process 201-3. As noted above, the system process 201-3 has responsibility for these children processes 201-4 and 201-5 which includes restarting (e.g., “respawning”) these children processes if they terminate inappropriately and is responsible for cleaning up after these children processes when they have properly completed, among other tasks and responsibilities.

As one of ordinary skill in the art will appreciate from reading this disclosure, the system process has many responsibilities to handle. As a result, the responsibility to “wait on” orphaned processes may be low on the system process' priority list. The same reader will appreciate that some parent processes may have as their responsibility the task of spawning/starting many children processes (e.g., 10-500 children processes) and then go away. Thus, an accumulating number of orphaned processes lying around and awaiting to be cleaned up by the system process may begin to interfere with a system's performance such that a system no longer performs at its full potential. Embodiments of the present invention rectify this potential situation as discussed further in connection with FIG. 2C.

FIG. 2C illustrates another detail level for a system process representation 201-3 according to an embodiment of the present invention. As shown in the embodiment of FIG. 2C, when a system process 201-3 is initiated it sets up its process data 203 and threads 205, e.g., starts at least one primary thread of execution 209 which maintains all of the system process 201-3 responsibilities, including but not limited to starting other children processes in its configuration file as the same will be known and understood by one of ordinary skill in the art and cleaning up orphaned children processes. Additionally, however, the system process 201-3 embodiments of the present invention start one or more secondary threads, e.g., 211-1, 211-2, . . . , 211-O, which are dedicated to cleaning up orphaned children processes. As one advantage, the one or more secondary threads, 211-1, 211-2, . . . , 211-O, can run, e.g., execute, on a second physical processor (such as illustrated in the embodiment of FIG. 1B) from the primary thread 209. In this manner, the first thread, or primary thread, remains unchanged by the activities, e.g., tasks, of the one or more secondary threads in cleaning up orphaned children processes.

According to various embodiments the one or more secondary threads, 211-1, 211-2, . . . , 211-O, can run, e.g., execute, as posix real time threads on a global system wide list, as the same will be known and understood by one of ordinary skill in the art, rather than being assigned to one particular processor. In this manner, the one or more secondary threads, 211-1, 211-2, . . . , 211-O, can run, e.g., execute, as higher priority process specific threads than if they were awaiting a single processor being used by other threads of the system process 201-3.

According to various embodiments, when the one or more secondary threads, 211-1, 211-2, . . . , 211-O, want to clean up orphaned children processes these one or more secondary threads, 211-1, 211-2, . . . , 211-O, can run, e.g., execute, a function call to wait on the orphaned children processes. Since the one or more secondary threads, 211-1, 211-2, . . . , 211-O, are dedicated to cleaning up orphaned children threads they can be written in a more tight segment of code, e.g., tens (10s) of lines of code, in comparison to threads which are written as sets of instruction with multiple responsibilities. In other words, once a secondary thread, which will be referred to herein as an orphan collector thread (OCT), has executed to clean up accumulated orphaned threads it has no further responsibilities and can return to an “idle” state.

As one of ordinary skill in the art will appreciate upon reading this disclosure, the one or more secondary threads, 211-1, 211-2, . . . , 211-O, can run, e.g., execute, according the a thresholding scheme. That is, the system process 201-3 can maintain and track, e.g., store and reference in its process data, the number of orphaned children processes which have been given over to it, e.g., adopted, as well as when they were adopted, e.g., how long various orphaned children process have been waiting to be cleaned up. According to various embodiments, the one or more secondary threads, 211-1, 211-2, . . . , 211-O, can run, e.g., execute, a function call to the wait on the orphaned children processes once various, user selectable, orphaned children process count thresholds have been reached. For example, as will be discussed in more detail below, one secondary orphan collector thread (OCT) can be started as the system process is initiated and that OCT can hold off on making a function call to wait on orphaned children processes until a designated first threshold count has been reached, e.g., once more than 200 orphaned children processes are awaiting to be cleaned up. In this manner, the embodiments will defray any concern over creating system perturbations due to OCTs executing on additional separate physical processors in more real time than in awaiting execution on the particular processor which the system process' 201-1 primary threads are executing. As will be discussed below, various additional, user selectable, count threshold can be established at which time the system process will start additional OCTs.

One of ordinary skill in the art will appreciate upon reading this disclosure the manner in which various, user selectable, count threshold can be implemented with the embodiments of the system process described herein. Another advantage to the ability to implement various, user selectable, count thresholds is that the various count thresholds can be scaled by user input as suitable to various systems and operating conditions. For example, to check the efficacy of the one or more secondary threads, 211-1, 211-2, . . . , 211-O, the thresholds can be set lower and/or higher during a particular “testing” operation in order to aggressively execute function calls ability and response to wait on orphaned children process and/or evaluate a impact to performance on the system at higher count thresholds. Similarly, then the count thresholds can be adjusted lower and/or higher to particular customer and/or productions specifications.

FIG. 3A illustrates an embodiment for thresholding orphan collector threads (OCTs). As illustrated in the embodiment of FIG. 3A, until a first level is reached, e.g., level A associated with a first count threshold, an OCT will hold off on making a function call to wait on orphaned children processes leaving the responsibility of cleaning up to the primary threads 209 of the system process 201-3. As illustrated in the embodiment of FIG. 3A, once the orphaned count threshold at level A has been reached and/or exceeded, then one OCT, e.g., a first secondary thread, will be allowed to execute in order to help in cleaning up the orphaned children processes.

As shown in FIG. 3A, any number (as indicated by the designation “X”) of arbitrary count thresholds can be established at which time additional OCTs, e.g., subsequent secondary threads, can be started and allowed to execute to aid in cleaning up orphaned children processes as practicable or suited to a particular system. Thus, once another count threshold is reached, e.g., level B associated with another count threshold, another OCT will start and be allowed to execute making function calls to wait on orphaned children processes. One of ordinary skill in the art will appreciate upon reading this disclosure, this sequence can continue through various, user selectable, count thresholds, e.g., level C on through level X-1, level X, etc.

As another advantage to the various system process embodiments the system process can have another thresholding hierarchy associated with how long an OCT executes to clean up orphaned children processes. For example, at various, user selectable, numbers of cleaned up orphaned children by a given OCT the OCT can execute a function call to pause cleaning up the orphaned children processes thereby releasing system resources, e.g., freeing a particular processor, etc. In this manner, by forcibly giving up a processor once in a while a real time thread will be able to block in the kernel operating system for a significant time period, within the various threshold described above, such that the OCT does not bounce around to an extensive degree. One of ordinary skill in the art will appreciate upon reading this disclosure the manner in which a thresholding hierarchy associated with how long an OCT executes to clean up orphaned children processes, according to various, user selectable thresholds, can be implemented with the embodiments of the system process described herein.

FIG. 3B serves to illustrate considerations which exemplify the benefits of thresholding OCTs according to various embodiments of the present invention. In complement to the advantages described above, FIG. 3B aids in illustrating that embodiments of the present invention assist in avoiding priority inversion as the same will be understood by one of ordinary skill in the art.

That is, if three threads (e.g., labeled for convenience in a processing order as A, B, and C and having equal priority) are all eligible to run at the same time, A will be selected first to run, occupying a processor resource until it is through, then thread B will have access to the processor next, and then once thread B is through thread C will have access to the processor resource.

For comparison, FIG. 3B illustrates the example in which threads A, B, and C are not all of the same priority and are not requesting a particular processor resource at the same time. In FIG. 3B, a variance of the above example is provided in which thread B has a highest priority, threads requests and a particular processor resource first in time, and thread A requests the particular processor resource second in time. The three threads, A, B, and C, are illustrated on the vertical axis with the horizontal axis representing time at which a particular thread requests use of the particular processor. In the example, thread C requests and obtains exclusive use of the processor resource first in time. Next, while thread C has exclusive use of the processor, thread A requests use of the same processor resource. Here, thread A will be waiting for thread C to release that processor resource. If thread B requests use of the processor resource to run, e.g., execute instructions, thread B having the higher priority will prevent thread C from continuing to run, execute, on the particular processor resource. In effect, by obtaining the particular processor resource thread B will prevent the earlier in time threads, e.g., threads C and A, from running and executing their tasks. This is generally referred to as priority inversion. Here, thread A starves waiting for thread C to complete, and thread C can starve waiting for thread B to complete.

One of ordinary skill in the art will appreciate from reading this disclosure that the system process embodiments of the present invention can reduce this above described occurrence of priority inversion. The system process embodiments described herein start and dedicate secondary OCTs which can execute on additional physical processors from the particular processor being used by the system process' primary threads, e.g., other responsibilities. The dedicated OCTs are provided with thresholding to avoid perturbing the system's load and to release processor resources from time to time. The secondary OCTs can be written in a much smaller code space than used for threads having other responsibilities.

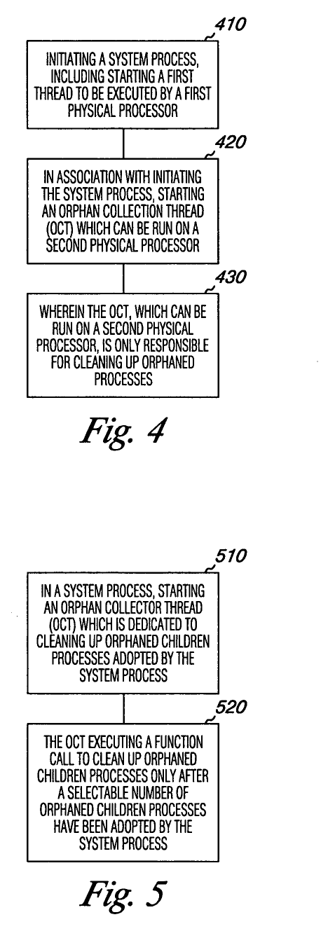

FIGS. 4 and 5 illustrate various method embodiments for process management. As one of ordinary skill in the art will understand, the embodiments can be performed by software/firmware (e.g., computer executable instructions also referred to as “code”) operable on the devices shown herein or otherwise. The embodiments of the invention, however, are not limited to any particular operating environment or to executable instructions written in a particular programming language. Software/firmware, application modules, and/or computer executable instructions, suitable for carrying out embodiments of the present invention, can be resident in one or several locations.

Unless explicitly stated, the method embodiments described herein are not constrained to a particular order or sequence. Additionally, some of the described method embodiments or elements thereof can occur or be performed at the same point in time.

FIG. 4 illustrates one method embodiment for process management. In the embodiment of FIG. 4, the method includes initiating a system process, including starting a first thread, e.g., a primary thread, to be executed by a first physical processor as shown in block 410. One of ordinary skill in the art will appreciate upon reading this disclosure the manner in which a system process is initiated whether on a Unix, Windows, Mac, Linux, or other type of operating system environments. Embodiments of the invention are not limited to a particular operating system type. For example, in traditional Unix, an “init” process is generally responsible for initializing a system among other responsibilities. Accordingly, init starts, e.g., creates or spawns, other processes. Parent processes are responsible for restarting, e.g., respawning, the children they create if they have prematurely ended. Additionally, the parent process is responsible for cleaning up the children processes they create.

The system process of a given operating system is typically also given the responsibility of cleaning up children processes which were not cleaned up by their parent processes. Processes make function calls to the system operating system which call one or more subroutines and execute instructions to accomplish these tasks. In the Unix example, a process is to be “waited on” (e.g., cleaned up after) by its parent. If the parent exits and fails to do this, the process is then adopted by the “init” process (a system daemon), which is then responsible for cleaning up (e.g., reaping) all orphaned children processes on the system that were not reaped by their parent. One of ordinary skill in the art will appreciate upon reading this disclosure that in such a process management subsystem, when a process is orphaned to init, its structure can be marked as having been “adopted” at the time the parent process is changed.

When a process is given to init its structure can be marked as “p_adopted_by_init.” While init remains with a single list of children, one of ordinary skill in the art will appreciate it is easy to identify with some reasonable degree of accuracy which children processes init actually started and which ones it did not. In Unix example, the init process would be single threaded and have restrictions placed on its scheduling priorities thus creating a scaling bottleneck on systems with a high rate of processes being given to Unix.

Accordingly, as shown in block 420, the method embodiment of FIG. 4 includes starting an orphan collection thread (OCT) in association with initiating the system process. In various embodiments, the OCT is a secondary thread that can be run on a physical processor different from a processor on which a primary thread of the system process is running. As shown in block 430, the OCT is only responsible for cleaning up orphaned processes. In various embodiments, the method further includes starting additional OCTs at one or more various, selectable thresholds representing a number of orphaned processes which have been adopted by the system process and are waiting to be cleaned up.

By way of example and not by way of limitation, the following particular implementation of this method embodiment is described with reference to Unix. In “kernel space” the process management system will provide a new flag to the init, as the same will be appreciated by one of ordinary skill in the art. This flag is both specifically and only for init, e.g., the system process.

That is, this new flag will only be used for init, e.g., the system process. When this flag is used, the system process will only reap, e.g., clean up, adopted children processes which have terminated, e.g., inherited terminated children processes of init. The system process using this flag will have no other purpose than cleaning up inherited terminated children processes. For example, the OCT will call wait/waitpid with this new flag to clean up orphaned children processes. As one of ordinary skill in the art will appreciate upon reading this disclosure, due to this new flag, the OCT will only select processes that were “adopted” by init. Hence, anything the OCT reaps will not need to be respawned. In this manner, the OCT can avoid all need for “user space” to synchronize around threads which do, and do not need to be respawned.

According to various embodiments, discussed herein, the new flag can be associated with one or more threshold. That is, as an over load of this flag, it will only reap when init is having difficulty collecting an accumulating number of orphaned children processes, e.g., once a certain number count (which can be user selectable) of orphaned children processes have been adopted but not yet cleaned up. When init is not having difficulty collecting, e.g., cleaning up, orphaned processes, the OCT will block for a period of time, and then check again. By way of example and not by way of limitation using the Unix example, if after a certain numbered (e.g., second or otherwise) subsequent check fails (e.g., init still does not need help), the OCT can return to ESRCH, as the same will be understood by one of ordinary skill in the art. One of ordinary skill in the art will appreciate that such a design will avoid having the OCT be called and then remaining in kernel space an inordinate amount of time. One of ordinary skill in the art will further appreciate that since some things only happen upon going out to user space, it is desirable to ensure that the transition to user space occurs on some reasonable interval.

In a user space portion, at start up init spawns a second (and possibly third, or greater number) thread. This new thread (referred to herein as OCT) first sets itself to realtime, and then masks off most signals, leaving only the unmaskable, and some like SIGSEGV enabled, as the same will be understood by one of ordinary skill in the art. In various embodiments, the OCT is a portable operating system interface for Unix (posix) thread on a global system wide list. This OCT will sit in a loop calling wait with the new flag. Every “N”, for some arbitrary value of N, successful calls it will call nanosleep(1). This call to nanosleep ensures that as an realtime thread, the OCT forcibly gives up the processor once in a while. The OCT will block in the kernel for a measurable time period if its assistance for cleaning up orphaned children processes is unnecessary, ensuring the OCT does not unnecessarily bounce around. For example, the OCT will only wait on orphaned children processes once certain thresholds have been reached. The kernel can alter the levels, e.g. thresholds, of when init considered to be having difficulty (e.g., “in trouble”) collecting the orphaned children processes based on the flavor of the kernel, e.g., as suited to the particular choice of operating conditions. One of ordinary skill in the art will appreciate that this permits better code coverage by having init be “in trouble” almost all of the time during testing operating conditions. Along with altering the thresholds, the kernel can start one or more additional OCTs to wait on orphaned processes once one or more second thresholds have been reached. These thresholds can all be variably established based on user input.

FIG. 5 illustrates another method embodiment for process management in a system process. In the embodiment of FIG. 5, the method includes starting an orphan collector thread (OCT) which is dedicated to cleaning up orphaned children processes adopted by the system process as shown in block 510. Starting an orphaned thread includes any of the methods, example, and manners which have been discussed herein.

As shown at block 510, the OCT will execute a function call to clean up orphaned children processes only after a selectable number of “non-reaped” orphaned children processes have been adopted by the system process. According to various embodiments the method includes using the OCT to wait on orphaned processes once a first threshold has been reached. One of ordinary skill in the art will appreciate that the first threshold can be variably established based on user input. In the various embodiments the first threshold is associated with a number representing how many orphaned processes have been given to the system process. One or more additional OCTs can be started to wait on orphaned processes once one or more second thresholds have been reached. Similarly, the one or more second thresholds can be variably established based on user input. And, in various embodiments the one or more second thresholds are associated with one or more additional numbers representing how many orphaned processes have been given to the system process. As has been described herein, additional thresholds can be established according to the system process embodiments such that a particular OCT will release a processor resource being used to clean up orphaned children processes after a selectable number of orphaned children processes have been cleaned up. As described above, the OCT becomes idle when the OCT is not cleaning up orphaned children processes.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for process management on a computing device, comprising:
initiating a system process, including starting a thread to be executed by a physical processor;
in association with initiating the system process, starting an orphan collection thread (OCT); and
wherein the OCT is only responsible for cleaning up processes that have terminated and been assigned to the system process.

2. The method of claim 1, further including associating a flag with processes that have terminated and been assigned to the system process.

3. The method of claim 1, further including providing a system call to only clean up processes which have a flag indicating a process has been adopted by the system process and has terminated.

4. The method of claim 1, further including adding an option to a system wait call to only clean up processes which are flagged as having been adopted by the system process and which have terminated.

5. The method of claim 1, wherein the OCT can be run on a different physical processor.

6. A computer readable medium having a program to cause a device to perform a method, comprising:
in a system process, starting an orphan collector thread (OCT) which is dedicated to cleaning up orphaned children processes adopted by the system process; and
wherein the OCT will execute a function call to clean up orphaned children processes only after a selectable number of non-reaped orphaned children processes have been adopted by the system process.

7. The medium of claim 6, wherein the OCT will release a processor resource being used to clean up orphaned children processes after a selectable number of orphaned children processes have been cleaned up.

8. The medium of claim 7, wherein the OCT becomes idle when the OCT is not cleaning up orphaned children processes.

9. The medium of claim 8, wherein the method further includes starting additional OCTs at one or more various, selectable thresholds representing a number of orphaned processes which have been adopted by the system process and are awaiting to be cleaned up.

10. The medium of claim 6, wherein the OCT is a secondary thread that can be run on a physical processor different from a processor on which a primary thread of the system process is running.

11. The medium of claim 6, wherein the OCT is a portable operating system interface for Unix (posix) thread on a global system wide list.

12. A multithreaded computing system, comprising:
a first processor;
a second processor
a memory coupled to the first and the second processors; and
program instructions provided to the memory and executable by the system to:
initiate a system process, including starting a first thread to be executed by the first processor; and
in association with initiating the system process, starting an orphan collection thread (OCT) which can be executed on the second processor;
wherein the OCT is only responsible for cleaning up orphaned processes.

13. The system of claim 12, wherein the OCT is executed to wait on orphaned processes once a first threshold has been reached.

14. The system of claim 13, wherein the first threshold is variably established the based on user input.

15. The system of claim 14, wherein the first threshold is associated with a number representing how many non-reaped orphaned processes have been given to the system process.

16. The system of claim 12, wherein the program instructions further execute to start one or more additional OCTs to wait on orphaned processes once one or more second thresholds have been reached.

17. The system of claim 16, wherein one or more second thresholds are variably established the based on user input.

18. The system of claim 17, wherein the one or more second thresholds are associated with one or more additional numbers representing how many non-reaped orphaned processes have been given to the system process.

19. The system of claim 12, wherein the OCT includes a set of executable instructions which are contained in fewer than fifty lines of code.

20. A computing device, comprising:
a processor;
a memory coupled to the processor; and
program instructions provided to the memory and executable by the processor, the program instructions are part of a process management system to:
in a system process, starting an orphan collector thread (OCT) which is dedicated to cleaning up orphaned children processes adopted by the system process; and
wherein the OCT will execute a function call to clean up orphaned children processes only after a selectable number of non reaped orphaned children processes have been adopted by the system process.

21. The device of claim 20, wherein the OCT will release a processor resource being used to clean up orphaned children processes after a selectable number of orphaned children processes have been cleaned up.

22. The device of claim 21, wherein the OCT becomes idle when the OCT is not cleaning up orphaned children processes.

23. The device of claim 20, wherein the program instructions execute to start additional OCTs at one or more various, selectable thresholds representing a number of non reaped orphaned processes which have been adopted by the system process and are awaiting to be cleaned up.

24. The device of claim 20, wherein the OCT is a secondary thread that can be run on a physical processor different from a processor on which a primary thread of the system process is running.

25. The device of claim 20, wherein the OCT is a portable operating system interface for Unix thread on a global system wide list.

26. A process management system, comprising:
means for dedicating a thread in a system process to cleaning up orphaned children processes given to the system process; and
means for scaling various thresholds at which the thread executes to clean up orphaned children processes given to the system process.
